(19) United States
(12) Patent Application Publication
(10) Pub. No.: US 2022/0073422 A1
(43) Pub. Date: Mar. 10, 2022

(54) Glass Substrate Multilayer Structure, Method of Producing the Same, and Flexible Display Panel Including the Same

(71) Applicants: SK Innovation Co., Ltd., Seoul (KR); SK ie technology Co., Ltd., Seoul (KR)

(72) Inventor: Cheol Min Yun, Daejeon (KR)

(21) Appl. No.: 17/412,702

(22) Filed: Aug. 26, 2021

(30) Foreign Application Priority Data
Sep. 4, 2020 (KR) 10-2020-0112837

(51) Int. Cl. C03C 17/34

(52) U.S. Cl. CPC C03C 17/3405; C03C 2218/365; C03C 2217/78

(57) ABSTRACT

Provided are a glass multilayer structure, a method of producing the same, and a flexible display panel including the same. Specifically, a glass substrate multilayer structure including: a flexible glass substrate, an epoxy siloxane-based hard coating layer formed on one surface of the flexible glass substrate, and a polyimide-based shatterproof layer formed on the other surface of the flexible glass substrate, and a flexible display panel including the same are provided.

### CROSS-REFERENCE TO RELATED APPLICATION

This application claims priority to Korean Patent Application No. 10-2020-0112837 filed Sep. 4, 2020, the disclosure of which is hereby incorporated by reference in its entirety.

### BACKGROUND OF THE INVENTION

### Field of the Invention

The following disclosure relates to a glass substrate multilayer structure, a method of producing the same, and a flexible display panel including the same.

### Description of Related Art

In recent years, thinner display devices are required with the development of mobile devices such as smart phones and tablet PCs, and among them, a flexible display device which may be curved or foldable when a user wants or a flexible display device of which the manufacturing process includes curving or folding is receiving attention.

The display device includes a transparent window covering a display screen, and the window has a function of protecting the display device from external impact, scratches applied during the use, and the like.

Glass or tempered glass which is a material having excellent mechanical properties is generally used for a window for displays, but conventional glass has no flexibility and results in a higher weight of a display device due to its weight.

In order to solve the problem described above, a technology to make a flexible glass substrate thinner has been developed, but is not sufficient for implementing flexible properties capable of being curved or bent, and the problem of being easily broken by an external impact has currently yet to be solved.

In particular, in the case of a flexible display device, a glass substrate window is easily broken by external impact or in the process of curving or folding and the fragments shatter to cause a user to be injured. In addition, in order to solve the above, efforts have been made to solve the problems by forming a shatterproof layer on a flexible glass thin film, but when it is shrunk by thermal hysteresis or the like, a problem of deformation of a glass substrate and deformation of a glass multilayer structure in which a shatterproof layer is formed has yet to be solved.

Accordingly, the development of a novel multilayer structure, which solves deformation problems of a glass substrate and glass substrate multilayer structure due to an external stress such as the thermal hysteresis, has improved durability, improves a shattering phenomenon when the glass substrate is broken to secure a user's safety, and has improved thermal resistance and optical properties, is currently needed.

### SUMMARY OF THE INVENTION

An embodiment of the present invention may be realized by providing a novel thin film glass substrate multilayer structure which, when a thin film glass substrate is used as a substrate, prevents a bending occurrence in edge portions or center portions of a glass substrate due to thermal shrinkage and thermal expansion by curing when forming a shatterproof layer and a hard coating layer. In addition, a glass substrate multilayer structure capable of being applied to a flexible display device, which has an excellent surface hardness to have excellent impact resistance (pen drop) properties even at the same thickness as compared with a conventional plastic, is to be provided.

Thus, another embodiment of the present invention may be realized by providing a glass substrate multilayer structure which solves a deformation problem arising when a shatterproof layer is formed on a conventional flexible thin film glass substrate, and simultaneously, provides excellent surface properties so as to have no pen mark when a dropped from a high position of 30 cm or higher in a pen drop test.

Still another embodiment of the present invention may be realized by providing a glass substrate multilayer structure capable of being applied to a flexible display device, which has excellent durability and shatter resistant properties to secure a user's safety, has flexible properties to allow being curved or bent, so that glass is not broken or not cracked even when repeating curving or folding.

In one general aspect, a glass substrate multilayer structure includes: a flexible glass substrate; an epoxy siloxane-based hard coating layer formed on one surface of the flexible glass substrate; and a polyimide-based shatterproof layer formed on the other surface of the flexible glass substrate.

In an exemplary embodiment of the present invention, the polyimide-based shatterproof layers may be formed of a polyimide-based resin including a unit derived from a fluorine-based aromatic diamine and a unit derived from an aromatic dianhydride.

In an exemplary embodiment of the present invention, the epoxy siloxane-based hard coating layer may be formed by including an epoxy siloxane-based resin including a unit derived from an alicyclic epoxidized silsesquioxane-based compound.

In an exemplary embodiment of the present invention, the flexible glass substrate may have a thickness of 1 to 100 μm.

In an exemplary embodiment of the present invention, the polyimide-based shatterproof layer may have a thickness of 100 nm to 10 μm.

In an exemplary embodiment of the present invention, the epoxy siloxane-based hard coating layer may have a thickness of 1 μm to 5 μm.

In an exemplary embodiment of the present invention, the epoxy siloxane-based hard coating layer may have a pencil hardness of 4H to 6H in accordance with ASTM D3363.

In an exemplary embodiment of the present invention, the epoxy siloxane-based hard coating layer may have a transmittance of 90% or more.

In an exemplary embodiment of the present invention, the glass substrate multilayer structure may have an impact resistance of 10 cm or more by a pen drop test.

In another general aspect, a method of producing a glass substrate multilayer structure includes: applying a shatterproof composition on one surface of a flexible glass substrate and curing the shatterproof composition to form a polyimide-based shatterproof layer; and applying a hard coating composition on the other surface of the flexible glass substrate and curing the hard coating composition to form an epoxy siloxane-based hard coating layer.

In an exemplary embodiment of the present invention, the shatterproof composition may include a fluorine-based aromatic diamine and an aromatic dianhydride.

In an exemplary embodiment of the present invention, the hard coating composition may include an epoxy siloxane-based resin including a unit derived from an alicyclic epoxidized silsesquioxane-based compound, a crosslinking agent, and a photoinitiator.

In still another general aspect, a flexible display includes the glass substrate multilayer structure.

Other features and aspects will be apparent from the following detailed description, the drawings, and the claims.

### BRIEF DESCRIPTION OF THE DRAWING

FIG. 1 is an exploded perspective view which schematically shows a cross-section of a glass substrate multilayer structure according to an exemplary embodiment of the present invention.

### DETAILED DESCRIPTION OF MAIN ELEMENTS

10: flexible glass substrate
20: polyimide-based shatterproof layer
30: epoxy siloxane-based hard coating layer
100: glass substrate multilayer structure

### DESCRIPTION OF THE INVENTION

The terms used in the present disclosure have the same meanings as those commonly understood by a person skilled in the art. In addition, the terms used herein are only for effectively describing a certain specific example, and are not intended to limit the present disclosure.

The singular form used in the specification of the present disclosure and the claims appended thereto may be intended to also include a plural form, unless otherwise indicated in the context.

Throughout the present specification describing the present disclosure, unless explicitly described to the contrary, “comprising” any elements will be understood to imply further inclusion of other elements rather than the exclusion of any other elements.

The terms such as “first” and “second” used in the present specification may be used to describe various constituent elements, but the constituent elements are not to be limited by the terms. The terms are only used to differentiate one constituent element from other constituent elements.

The term “flexible” in the present disclosure refers to being curved, bent, or folded.

The term “shatterproof layer” in the present disclosure may be used to refer to including a “polyimide-based shatterproof layer”, specifically, a “polyimide-based shatterproof layer containing a fluorine element”.

The term “hard coating layer” in the present disclosure is used to refer to including an “epoxy siloxane-based hard coating layer”.

The inventors of the present disclosure conducted many studies to solve the above problems, and as a result, may provide a flexible glass substrate multilayer structure which solves problems due to deformation or long-term deformation of a glass substrate multilayer structure, by forming a polyimide-based shatterproof layer, in particular, a polyimide-based shatterproof layer containing a fluorine element, on one surface of a flexible glass substrate and forming an epoxy siloxane-based hard coating layer on the other surface of the flexible glass substrate, which is an opposite surface to the surface having the polyimide-based shatterproof layer formed thereon to adjust tensile stresses of both layers. In addition, the inventors of the present disclosure found that a glass substrate multilayer structure which implements flexible properties and has excellent shatter resistant properties, impact resistance properties, and optical properties to be appropriate for being applied to a cover window of a flexible display panel may be produced, thereby completing the present disclosure.

Furthermore, the inventors of the present disclosure found that the polyimide-based shatterproof layer adopts a polyimide, in particular, a fluorine-containing polyimide, thereby having an effect of not causing a short-term or long-term deformation due to various external stresses such as thermal hysteresis on a flexible glass substrate, and interacts with the deformation of an epoxy siloxane-based hard coating layer so that the deformation such as bending of the polyimide-based shatterproof layer and the epoxy siloxane-based hard coating layer is suppressed. Specifically, the inventors of the present disclosure found that by using a polyimide-based composition containing a fluorine element as a material forming the polyimide-based shatterproof layer, a deformation prevention effect is further maximized with a combination with the epoxy siloxane-based hard coating layer, and also, thermal resistance and optical properties are excellent while shatter resistant properties are excellent, thereby completing the present disclosure.

Hereinafter, each constituent of the present disclosure will be described in detail with reference to a drawing.

However, these are only illustrative and the present disclosure is not limited to the specific embodiments which are illustratively described in the present disclosure.

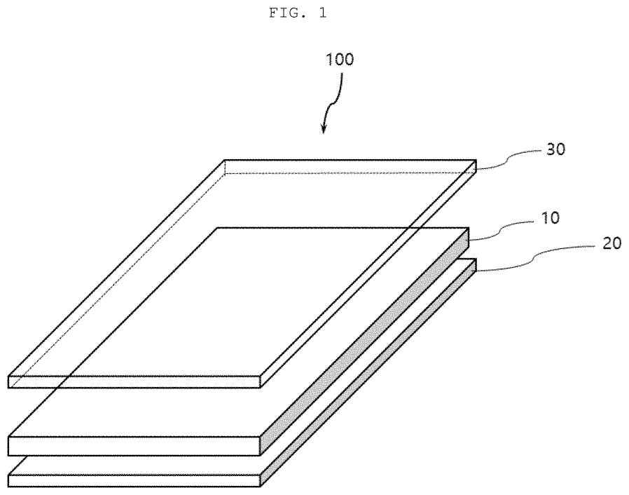

FIG. 1 is a schematic exploded perspective view illustrating a glass substrate multilayer structure according to an exemplary embodiment of the present invention. As seen in FIG. 1, the glass substrate multilayer structure 100 according to an exemplary embodiment of the present invention includes a polyimide-based shatterproof layer 20 formed on one surface of a flexible glass substrate 10 and an epoxy siloxane-based hard coating layer 30 formed on the other surface of the flexible glass substrate 10.

The glass substrate multilayer structure according to an exemplary embodiment of the present invention may have a pencil hardness on a surface having the hard coating layer 30 formed thereon of 3H or more, specifically, 4H or more, in accordance with ASTM D3363. In addition, the glass substrate multilayer structure may have an impact resistance of 10 cm or more, more specifically, 30 cm or more, by a pen drop test. Here, the impact resistance properties by the pen drop test refer to a state in which there is no surface nicks or press when a ballpoint pen having a diameter of 0.7 mm and a weight of 0.5 g is vertically dropped.

The glass substrate multilayer structure according to an exemplary embodiment of the present invention may have a value within ±0.4 mm, specifically, within ±0.38 mm or ±0.2 mm in bending properties.

The bending properties are obtained by measuring a bending degree of the glass substrate multilayer structure at room temperature, immediately after forming the first polyimide-based shatterproof layer, second polyimide-based shatterproof layer, and the hard coating layer on a glass substrate having a width of 180 mm×a length of 76 mm×a thickness of 40 μm. When the glass substrate multilayer structure is curved in a direction of a vibration isolation table and a center of the glass substrate is curved to an air layer, the value is represented as a negative (stress) value (mm) and conversely, when both ends (edges) of the glass substrate are curved in a direction of the air layer on the vibration isolation table, the value is represented as a positive (tension) value (mm).

When a polyimide forming the polyimide-based shatterproof layer is produced into a film, the glass substrate multilayer structure according to an exemplary embodiment of the present may have a modulus of 4 GPa or less, 3 GPa or less, or 2.5 GPa or less in accordance with ASTM E111, an elongation at break of 10% or more, 20% or more, or 30% or more, a light transmittance of 5% or more or 5 to 80% as measured at 388 nm and a total light transmittance of 87% or more, 88% or more, or 89% or more as measured at 400 to 700 nm, in accordance with ASTM D1746, a haze of 2.0% or less, 1.5% or less, or 1.0% or less in accordance with ASTM D1003, a yellow index of 5.0 or less, 3.0 or less, or 0.4 to 3.0 in accordance with ASTM E313, and a b* value of 2.0 or less, 1.3 or less, or 0.4 to 1.3. The glass substrate multilayer structure according to an exemplary embodiment of the present invention adopts a polyimide containing a fluorine element as a shatterproof layer forming material to form a polyimide-based shatterproof layer on one surface of a flexible glass substrate, thereby suppressing deformation due to the stress of the flexible glass substrate (for example, various external stresses such as thermal hysteresis), suppressing deformation of an epoxy siloxane-based hard coating layer formed on the other surface of the flexible glass substrate, and significantly improving deformation resistance of the glass substrate multilayer structure of the present disclosure as a whole.

Furthermore, the glass substrate multilayer structure according to an exemplary embodiment of the present invention may easily implement flexible properties with excellent flexibility as well as the effects described above, and has excellent impact resistance and shatter resistant properties, thereby securing a user's safety, and is transparent with excellent optical properties, so that it may be applied as a window cover of a flexible display panel.

Hereinafter, referring to FIG. 1, each component of a flexible glass substrate 10, a polyimide-based shatterproof layer 20, and an acrylic hard coating layer 30 will be described in detail.

<Flexible Glass Substrate 22

A flexible glass substrate refers to a foldable or curved glass substrate, may function as a window of a display device, and has good durability and excellent surface smoothness and transparency.

In an exemplary embodiment of the present invention, the glass substrate multilayer structure 100 may be formed on one surface of a flexible display panel or may be curved or folded in response to bending or folding. Here, in order for the glass substrate multilayer structure 100 to be deformed so as to be bent with a relatively small radius of curvature or be folded, a flexible glass substrate 10 should be formed of an ultra-thin glass substrate. In addition, the flexible glass substrate 10 may be an ultra-thin glass substrate, and may have a thickness of 100 μm or less, specifically, 1 to 100 μm or 30 to 100 μm.

In an exemplary embodiment of the present invention, the flexible glass substrate may further include a chemical reinforcement layer, and the chemical reinforcement layer may be formed by performing a chemical reinforcement treatment on any one or more surfaces of a first surface and a second surface of a glass substrate included in the flexible glass substrate, thereby improving the strength of the flexible glass substrate.

There are various methods of forming a chemical reinforcement-treated ultra-thin flexible glass substrate as such, and as an example, a method of preparing an original long glass having a thickness of 100 μm or less, processing the glass into a predetermined shape by cutting, chamfering, sintering, and the like, and subjecting the processed glass to a chemical reinforcement treatment may be included. As another example, an original long glass having a normal thickness is prepared and slimmed into a thickness of 100 μm or less, and then may be subjected to shape processing and a chemical reinforcement treatment sequentially. Here, slimming may be performed by any one selected from a mechanical method and a chemical method or both in combination.

<Polyimide-Based Shatterproof Layer>

In an exemplary embodiment of the present invention, the polyimide-based shatterproof layer may have a basic function to absorb energy generated when the glass substrate 10 is damaged, thereby preventing fragments of the glass substrate 10 from shattering. In addition, the thickness of the polyimide-based shatterproof layer formed on the opposite surface of the surface on which the epoxy siloxane-based hard coating layer is formed is formed to be 10 μm or less, whereby the polyimide-based shatterproof layer may serve to adjust the stresses of the hard coating layer and the glass substrate to prevent long-term or short-term deformation due to an external stress such as thermal hysteresis.

In an exemplary embodiment of the present invention, the polyimide-based shatterproof layer is formed by including a polyimide, in particular, a polyimide containing a fluorine element, thereby having an effect of suppressing the deformation such as bending and deformation of the flexible glass substrate due to an external stress such as thermal shrinkage and also suppressing the deformation of an epoxy siloxane-based hard coating layer described later.

In an exemplary embodiment of the present invention, when the polyimide-based shatterproof layer is formed of a polyimide-based resin including a unit derived from a fluorine-based aromatic diamine and a unit derived from an aromatic dianhydride, specifically, formed of a polyimideimide-based resin polymerized from a monomer including the fluorine-based aromatic diamine and the aromatic dianhydride, optical physical properties and mechanical physical properties are excellent and elasticity and restoration force are excellent, and also, an effect of preventing deformation of the glass substrate may be further enhanced.

In an exemplary embodiment of the present invention, as the fluorine-based aromatic diamine, any one or two or more selected from 1,4-bis(4-amino-2-trifluoromethylphenoxy)benzene (6FAPB), 2,2′-bis(trifluoromethyl)benzidine (TFMB), 2,2′-bis(trifluoromethyl)-4,4′-diaminodiphenyl ether (6FODA), and the like may be used. In addition, the fluorine-based aromatic diamine may be used in combination with other known aromatic diamine components, but the present invention is not limited thereto. By using the fluorine-based aromatic diamine as such, deformation of the glass substrate due to thermal hysteresis or the like by the polyimide-based shatterproof layer produced may be suppressed, shatter resistant properties may be further improved, optical properties may be further improved, and also a yellow index may be improved.

In an exemplary embodiment of the present invention, the aromatic dianhydride may be any one or two or more selected from 4,4′-hexafluoroisopropylidene diphthalic anhydride (6FDA), biphenyltetracarboxylic dianhydride (BPDA), oxydiphthalic dianhydride (ODPA), sulfonyl diphthalic anhydride (SO2DPA), (isopropylidenediphenoxy) bis(phthalic anhydride) (6HDBA), 4-(2,5-dioxotetrahydrofuran-3-yl)-1,2,3,4-tetrahydronaphthalene-1,2-dicarboxylic dianhydride (TDA), 1,2,4,5-benzene tetracarboxylic dianhydride (PMDA), benzophenone tetracarboxylic dianhydride (BTDA), bis(carboxylphenyl) dimethyl silane dianhydride (SiDA), bis(dicarboxyphenoxy) diphenyl sulfide dianhydride (BDSDA), ethylene glycol bis(anhydrotrimellitate (TMEG100), and the like, but is not limited thereto.

In an exemplary embodiment of the present invention, the fluorine-based aromatic diamine and the aromatic dianhydride may be used at a mole ratio of 1:0.8 to 1:1.2, specifically, 1:0.9 to 1:1.1, but is not limited thereto.

In an exemplary embodiment of the present invention, the polyimide-based shatterproof layer may have a thickness of 10 μm or less, and the lower limit is not particularly limited, but may be 100 nm.

<Hard Coating Layer>

Next, a hard coating layer will be described in detail.

The hard coating layer may function to protect the glass substrate multilayer structure from external physical and chemical damage and may have excellent optical and mechanical properties.

In an exemplary embodiment of the present invention, the epoxy siloxane-based hard coating layer 30 may be formed on the surface of the flexible glass substrate 10 on the other surface of which the polyimide-based shatterproof layer 20 is formed, and as an example, the surface of the flexible glass substrate 10 may be subjected to a chemical enhancement treatment or an epoxy siloxane-based hard coating layer 30 may be formed on the surface of the flexible glass substrate 10. As the hard coating layer, one or more hard coating layers formed of a material showing the same shrinkage properties may be further used, but the present disclosure is not limited thereto.

The hard coating layer may be formed by including a known hard coating layer forming material, and specifically, may be formed by including an epoxy siloxane-based resin.

In an exemplary embodiment of the present invention, the epoxy siloxane-based resin may include a silsesquioxane-based compound as a main component. Specifically, the silsesquioxane-based compound may be an alicyclic epoxidized silsesquioxane (epoxidized cycloalkyl substituted silsesquioxane)-based compound.

An example of the alicyclic epoxidized silsesquioxane-based compound may include a trialkoxysilane compound-derived repeating unit represented by the following Chemical Formula 1:

A-Si(OR)₃ [Chemical Formula 1]

wherein A is a C1 to C10 alkyl group substituted by a C2 to C7 epoxy group, R is independently of each other a C1 to C10 alkyl group, and the carbon of the C1 to C10 alkyl group may be substituted by oxygen.

In Chemical Formula 1, an example of the epoxy group may be a cycloalkyl-fused epoxy group, and a specific example thereof may be a cyclohexylepoxy group and the like.

Here, a specific example of the alkoxysilane compound may be one or more of 2-(3,4-epoxycyclohexyl)methyltrimethoxysilane, 2-(3,4-epoxycyclohexyl)ethyltrimethoxysilane, 2-(3,4-epoxycyclohexyl)methyltriethoxysilane, 2-(3,4-epoxycyclohexyl)ethyltriethoxysilane, 3-glycidoxypropyltrimethoxysilane, but the present disclosure is not limited thereto.

In addition, in an exemplary embodiment of the present invention, the silsesquioxane-based compound also includes a diakoxysilane compound-derived repeating unit represented by the following Chemical Formula 2, together with the trialkoxysilane compound-derived repeating unit represented by Chemical Formula 1. In this case, the silsesquioxane-based compound may be prepared by mixing 0.1 to 100 parts by weight of the dialkoxysilane compound with respect to 100 parts by weight of the trialkoxysilane compound and performing condensation polymerization:

A-SiRₐ(OR)₂ [Chemical Formula 2]

wherein Rₐ is a linear or branched alkyl group selected from C1 to C5, and A and R are as defined in Chemical Formula 1.

A specific example of the compound of Chemical Formula 2 may include 2-(3,4-epoxycyclohexyl)ethylmethyldimethoxysilane, 2-(3,4-epoxycyclohexyl)ethylpropyldimethoxysilane, 2-(3,4-epoxycyclohexyl)ethylmethyldiethoxysilane, 2-(3,4-epoxycyclohexyl)ethylmethyldiethoxysilane, and the like, but is not limited thereto, and the compound may be used alone or in combination of two or more.

In an exemplary embodiment of the present invention, the hard coating layer may further include inorganic particles, and the inorganic particles may include any one or two or more selected from the group consisting of silica and metal oxides.

A specific example of the metal oxide may include alumina, titanium, and the like, and though it is not limited thereto, for example, silica may be used in terms of compatibility with other components of the hard coating composition described later. These may be used alone or in combination of two or more. In addition, the inorganic particles may further include particles selected from a hydroxide such as aluminum hydroxide, magnesium hydroxide, and potassium hydroxide; metal particles such as gold, silver, copper, nickel, and an alloy thereof; conductive particles such as carbon, carbon nanotube, and fullerene; glass; ceramic; and the like, but are not limited thereto.

In an exemplary embodiment of the present invention, the inorganic particles may have an average particle diameter of 1 to 200 nm, and specifically, 5 to 180 nm, and within the average particle diameter range, inorganic particles having two or more different average particle diameters may be used, but are not limited thereto.

In addition, the hard coating layer may further include a lubricant. The lubricant may improve winding efficiency, blocking resistance, wear resistance, scratch resistance, and the like. As a specific example of the lubricant, waxes such as polyethylene wax, paraffin wax, synthetic wax, or montan wax; synthetic resins such as silicon-based resin and fluorine-based resin; and the like may be used, and these may be used alone or in combination of two or more.

In an exemplary embodiment of the present invention, the epoxy siloxane-based hard coating layer may have a thickness of 500 nm to 30 μm, specifically, 1 μm to 25 μm, 3 μm to 20 μm, 5 μm to 15 μm, or 1 μm to 5 μm, but is not limited thereto. When the layer has the thickness in the above range, an epoxy-based hard coating layer maintains flexibility while having excellent hardness, so that bending does not substantially occur.

In an exemplary embodiment of the present invention, the epoxy siloxane-based hard coating layer has a pencil hardness of 2H or more, 3H or more, or 4H or more, and the upper limit is not limited thereto, but for example, 6H. In addition, the epoxy siloxane-based hard coating layer may have no scratches at 10 times/1 Kgf, 20 times/1 Kgf, or 30 times/1 Kgf in scratch evaluation using steel wool (#0000, from Reveron), and may have a water contact angle of 80° or more, 90° or more, or 100° or more. In addition, the epoxy siloxane-based hard coating layer may have a transmittance of 90% or more, specifically, 95% or more, or 99% or more.

<Flexible Display Panel>

In an exemplary embodiment of the present invention, a flexible display panel or a flexible display device including the glass substrate multilayer structure according to the exemplary embodiment as a window cover may be provided.

In an exemplary embodiment of the present invention, a glass substrate multilayer structure 100 in the flexible display device may be used as an outermost surface window substrate of the flexible display panel. The flexible display device may be various image displays such as a common liquid crystal display device, an electroluminescent display device, a plasma display device, and a field emission display device.

<Method of Producing Glass Substrate Multilayer Structure>

Hereinafter, a method of producing a glass substrate multilayer structure according to an exemplary embodiment of the present invention will be described in detail.

The method of producing a glass substrate multilayer structure according to an exemplary embodiment of the present invention may include: applying a shatterproof composition on one surface of a flexible glass substrate and curing the shatterproof composition to form a polyimide-based shatterproof layer; and applying a hard coating composition on the other surface of the flexible glass substrate and curing the hard coating composition to form an epoxy siloxane-based hard coating layer.

First, a shatterproof composition in forming the polyimide-based shatterproof layer will be described.

In an exemplary embodiment of the present invention, the shatterproof composition may include a fluorine-based aromatic diamine and an aromatic dianhydride, and the fluorine-based aromatic diamine and the aromatic dianhydride may be the same as those described above. As a specific exemplary embodiment, the shatterproof composition may be a polyimide precursor prepared by dissolving the fluorine-based aromatic diamine in an organic solvent to obtain a mixed solution, to which the aromatic dianhydride is added to perform a polymerization reaction. Here, the reaction may be carried out under an inert gas or a nitrogen stream, or under anhydrous conditions. In addition, the temperature during the polymerization reaction may be −20° C. to 200° C. or 0° C. to 180° C., and the organic solvent which may be used in the polymerization reaction may be selected from N,N-diethylacetamide (DEAc), N,N-diethylformamide (DEF), N-ethylpyrrolidone (NEP), dimethylpropaneamide (DMPA), diethylpropaneamide (DEPA), or a mixture thereof.

Here, the polyimide precursor solution may be in the form of a solution dissolved in an organic solvent or may be a dilution of the solution in other solvents. In addition, when the polyimide precursor is obtained as a solid powder, this may be dissolved in an organic solvent to form a solution.

Thereafter, the polyimide precursor may be imidized, thereby preparing a polyimide solution (shatterproof composition). Here, as the imidization process, a known imidization method may be used without limitation, but a specific example includes a chemical imidization method, a thermal imidization method, and the like, and as an exemplary embodiment of the present invention, an azeotropic thermal imidization method or a chemical imidization method may be used.

In the azeotropic thermal imidization method, toluene or xylene is added to a polyimide precursor (polyamic acid solution) and stirring is carried out to perform an imidization reaction at 160° C. to 200° C. for 6 to 24 hours, during which water released while an imide ring is produced may be separated as an azeotropic mixture of toluene or xylene.

The polyimide solution prepared according to the above preparation method may include a solid content in an amount to have an appropriate viscosity, considering processability such as coatabillity.

According to an exemplary embodiment, the shatterproof composition (polyimide solution) may have a solid content of 1 to 30 wt %, 5 to 25 wt %, or 8 to 20 wt %.

Hereinafter, a method of forming a polyimide-based shatterproof layer will be described.

In an exemplary embodiment of the present invention, the polyimide-based shatterproof layer may be formed by applying the shatterproof composition on each of the front and rear surfaces of the flexible glass substrate and curing the shatterproof composition. Here, the application method is not limited, but various methods such as bar coating, dip coating, die coating, gravure coating, comma coating, slit coating, or a combined method thereof may be used.

The curing may be a heat treatment at a temperature of 40° C. to 250° C., the number of heat treatments may be one or more, and the heat treatment may be performed once or more at the same temperature or in different temperature ranges. In addition, the heat treatment time may be 1 minute to 60 minutes, but is not limited thereto.

Hereinafter, the hard coating layer in forming the epoxy siloxane-based hard coating layer, according to an exemplary embodiment of the present invention, will be described.

In an exemplary embodiment of the present invention, the hard coating composition may include the epoxy siloxane-based resin described above, a crosslinking agent, and a photoinitiator, and specifically, may include an epoxy siloxane-based resin including a unit derived from the alicyclic epoxidized silsesquioxane-based compound described above, a crosslinking agent, and a photoinitiator.

In an exemplary embodiment of the present invention, the crosslinking agent may form crosslinks with the epoxy siloxane-based resin to solidify the hard coating layer forming composition and improve the hardness of the hard coating layer.

The crosslinking agent may contain, for example, a compound represented by the following Chemical Formula 3, and the compound represented by Chemical Formula 3 is the same alicyclic epoxy compound as the epoxy unit of the structures of Chemical Formulae 1 and 2, and may promote crosslinks and maintain a refractive index of the hard coating layer to cause no change in a viewing angle, may maintain bending properties, and may not damage transparency:

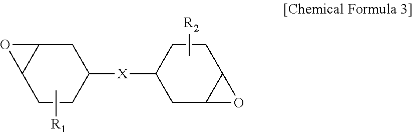

wherein R₁ and R₂ are independently of each other hydrogen or a linear or branched alkyl group having 1 to 5 carbon atoms, and X is a direct bond; a carbonyl group; a carbonate group; an ether group; a thioether group; an ester group; an amide group; a linear or branched alkylene group, an alkylidene group, or an alkoxylene group having 1 to 18 carbon atoms; a cycloalkylene group or a cycloalkylidene group having 1 to 6 carbon atoms; or a linking group thereof.

Here, a “direct bond” refers to a structure which is directly bonded without any functional groups, and for example, in Chemical Formula 3, may refer to two cyclohexanes being directly connected to each other. In addition, a “linking group” refers to two or more substituents described above being connected to each other. In addition, in Chemical Formula 3, the substitution positions of R₁ and R₂ are not particularly limited, but when the carbon connected to X is set at position No. 1 and the carbons connected to an epoxy group are set at position Nos. 3 and 4, R₁ and R₂ may be substituted at position No. 6.

The content of the crosslinking agent is not particularly limited, and for example, may be 1 to 150 parts by weight with respect to 100 parts by weight of the epoxysilane-based resin. Within the content range, the viscosity of the hard coating composition may be maintained in an appropriate range, and coatability and curing reactivity may be improved.

In addition, in an exemplary embodiment of the present invention, the hard coating layer may be used by adding various epoxy compounds in addition to the compounds of the above chemical formulae, and the content may not exceed 20 parts by weight with respect to 100 parts by weight of the compound of Chemical Formula 3, but is not limited thereto as long as the features of the present disclosure are achieved.

In an exemplary embodiment of the present invention, the epoxy-based monomer may be included at 10 to 80 parts by weight with respect to 100 parts by weight of the hard coating layer forming composition. Within the content range, viscosity may be adjusted, a thickness may be easily adjusted, a surface is uniform, defects in a thin film do not occur, and hardness may be sufficiently achieved, but the present invention is not limited thereto.

In an exemplary embodiment of the present invention, the photoinitiator is a cationic photoinitiator, and may initiate condensation of an epoxy-based monomer including the compounds of the above chemical formulae. As the cationic photoinitiator, for example, an onium salt and/or an organic metal salt, and the like may be used, but the present invention is not limited thereto. For example, a diaryliodonium salt, a triarylsulfonium salt, an aryldiazonium salt, an iron-arene complex, and the like may be used, and these may be used alone or in combination of two or more.

The content of the photoinitiator is not particularly limited, and for example, may be 0.1 to 10 parts by weight or 0.2 to 5 parts by weight with respect to 100 parts by weight of the compound of Chemical Formula 1.

In an exemplary embodiment of the present invention, a non-limiting example of the solvent may include alcohol-based solvents such as methanol, ethanol, isopropanol, butanol, methyl cellosolve, and ethyl cellosolve; ketone-based solvents such as methyl ethyl ketone, methyl butyl ketone, methyl isobutyl ketone, diethyl ketone, dipropyl ketone, and cyclohexanone; hexane-based solvents such as hexane, heptane, and octane; benzene-based solvents such as benzene, toluene, and xylene; and the like. These may be used alone or in combination of two or more.

In an exemplary embodiment of the present invention, the solvent may be included in a residual amount excluding an amount of the remaining components in the total weight of the composition.

As an exemplary embodiment of the present invention, the hard coating layer forming composition may further include a thermal curing agent.

The thermal curing agent may include a sulfonium salt-based curing agent, an amine-based curing agent, an imidazole-based curing agent, an acid anhydride-based curing agent, an amide-based thermal curing agent, and the like, and specifically, a sulfonium-based thermal curing agent may be further used in terms of prevention of discoloration implementation of high hardness. These may be used alone or in combination of two or more.

The content of the thermal curing agent is not particularly limited, and for example, may be 5 to 30 parts by weight with respect to 100 parts by weight of the epoxy siloxane resin. When the thermal curing agent is contained in the above range, the hardness efficiency of the hard coating layer forming composition may be further improved to form a hard coating layer having excellent hardness.

In an exemplary embodiment of the present invention, by using the hard coating layer forming composition, the glass substrate multilayer structure may be physically protected, mechanical physical properties may be further improved, and bending durability may be further improved.

The method of polymerizing an alicyclic epoxidized silsesquioxane-based compound according to the present disclosure is not limited as long as it is known in the art, but for example, may be prepared by hydrolysis and condensation reactions between alkoxy silanes represented by Chemical Formulae 1 and 2 in the presence of water. Here, the hydrolysis reaction may be promoted by including a component such as an inorganic acid. In addition, the epoxy siloxane-based resin may be formed by polymerizing a silane compound including an epoxycyclohexyl group.

Here, the alicyclic epoxidized silsesquioxane-based compound may have a weight average molecular weight of 1,000 to 20,000 g/mol, and within the weight average molecular weight range, the hard coating layer forming composition may have an appropriate viscosity to improve flowability, coatability, curing reactivity, and the like.

In addition, the hardness of the hard coating layer prepared may be improved. Also, the flexibility of the hard coating layer may be improved to suppress a curl occurrence. Specifically, the alicyclic epoxidized silsesquioxane-based compound may have a weight average molecular weight of 1,000 to 18,000 g/mol or 2,000 to 15,000 g/mol. Here, the weight average molecular weight is measured using GPC.

Hereinafter, a method of forming an epoxy siloxane-based hard coating layer will be described.

In an exemplary embodiment of the present invention, the epoxy-based hard coating layer may be prepared by applying the hard coating composition on the other surface of the flexible glass substrate, which is an opposite surface of the surface on which the polyimide-based shatterproof layer is formed, and curing the hard coating composition. Here, the application method is not limited, but various methods such as bar coating, dip coating, die coating, gravure coating, comma coating, slit coating, or a combined method thereof may be used.

The curing may be performed by photocuring or thermal curing alone, or thermal curing after photocuring or photocuring after thermal curing.

As an exemplary embodiment of the present invention, the curing step may further include a drying step before the photocuring, and the drying may be performed at 30° C. to 70° C. for 1 to 30 minutes, but the present invention is not limited thereto.

In an exemplary embodiment of the present invention, by using the hard coating composition, the glass substrate multilayer structure layer may be physically protected and the mechanical physical properties may be further improved.

Hereinafter, the present disclosure will be described in more detail with reference to the Examples and Comparative Examples. However, the following Examples and Comparative Examples are only an example for describing the present disclosure in more detail, and do not limit the present disclosure in any way.

Hereinafter, the physical properties were measured as follows:

1) Pencil Hardness

A pencil hardness on the surface of the glass substrate multilayer structure produced in the Examples and the Comparative Examples was measured using pencils by hardness (Mitsubishi Pencil Co., Ltd.) under a load of 1 kg using a pencil hardness tester (Kipae E&T Co. Ltd.), in accordance with ASTM D3363. Here, the surface of the glass substrate multilayer structure on which the measurement was performed was the surface on which a hard coating layer was formed.

2) Evaluation of impact resistance properties (pen drop)

On glass substrate multilayer structure samples produced in the following Examples and Comparative Examples, a 0.7 mm BIC Orange pen was vertically positioned and dropped to a designated position, and the state of the glass substrate multilayer structure was evaluated based on the following criteria: Here, a dropping direction was to the surface on which a hard coating layer was formed.

<Evaluation Criteria>

⊚: no nicks and pressing

∘: nicks and pressing present

x broken (not shattered)

▴: different results in two evaluations

3) Bending Properties

The glass substrate multilayer structures produced in the following Examples and Comparative Examples were placed on a flat ground and a degree to which the glass substrate multilayer structure was bent upward or downward was measured, and when the edge portions of the glass substrate were bent upward, the value was shown as +, and when the portions were bent or curved downward, the value was shown as −.

Specifically, on a glass substrate having a width of 180 mm×a length of 76 mm×a thickness of 40 μm, each shatterproof layer and hard coating layer forming composition was applied and cured, and immediately after that, the glass substrate multilayer structure was placed on a correctly leveled vibration isolation table, and the bending of the glass substrate multilayer structure was measured at room temperature. Here, when the glass substrate multilayer structure was curved in a direction of the vibration isolation table and a center of the glass substrate was curved to an air layer, a step difference from the highest curve point portion of the center was measured based on the edge and shown as a negative (stress) value (mm), and conversely, when the both ends (edges) of the glass substrate were curved in a direction of the air layer on the vibration isolation table, a step difference of a raised edge was measured based on the center and shown as a positive (tension) value (mm).

4) Light Transmittance

A total light transmittance was measured at the entire wavelength area of 400 to 700 nm using a spectrophotometer (from Nippon Denshoku, COH-400) and a single wavelength light transmittance was measured at 388 nm using UV/Vis (Shimadzu, UV3600), on a film having a thickness of 50 μm, in accordance with the standard of ASTM D1746. The unit is %.

5) Yellow index (YI) and b* value

A yellow index and a b* value were measured using a colorimeter (from HunterLab, ColorQuest XE), on a film having a thickness of 50 μm, in accordance with the standard of ASTM E313.

6) Retardation (Rₜₕ)

A vertical retardation was measured at 5° intervals in an incidence angle range of 0 to 45° using RETS-100 (OTSUKA ELECTRONICS). Specifically, a specimen in a square shape having a sample size of 5 cm in width×5 cm in length was mounted on a sample holder and was fixed to 550 nm using a monochromator, and a retardation in a thickness direction (Rₜₕ) was measured in an incidence angle range of 0 to 45°:

Rₜₕ=[(nₓ+n_{y})/2−n_{z}]×d

wherein nₓ is a highest refractive index in in-plane refractive indexes, n_{y} is a refractive index perpendicular to nₓ in the in-plane refractive indexes, nₓ is a vertical refractive index, and d is a value calculated by converting a thickness of a glass substrate multilayer structure to 10 μm.

### [Preparation Example 1] Preparation of Polyimide-Based Shatterproof Layer Forming Composition

An agitator in which a nitrogen stream flowed was filled with 230 g of N,N-dimethylpropionamide (DMPA), and 41 g 2.2′-bis(trifluoromethyl)-4,4′-diaminophenylether (6FODA) was dissolved while the temperature of the reactor was maintained at 25° C. 50 g of ethylene glycol bis-anhydro trimellitate (TMEG100) was added to the 6FODA solution at the same temperature, and dissolved with stirring for a certain period of time. 50 g of toluene was added to a polyimide precursor solution prepared from the above reaction, a reflux was performed at 180° C. for 6 hours to remove water, and dimethylpropaneamide (DMPA) was added so that a solid content concentration was 20 wt % to prepare a shatterproof layer forming composition (polyimide solution).

### [Preparation Example 2] Preparation of Epoxy Siloxane-Based Hard Coating Layer Forming Composition

2-(3,4-epoxycyclohexyl)ethyltrimethoxysilane (ECTMS, TCI) and water were mixed at a ratio of 24.64 g:2.70 g (0.1 mol:0.15 mol) to prepare a reaction solution, which was added to a 250 mL 2-neck flask. 0.1 mL of a tetramethylammonium hydroxide catalyst (Aldrich) and 100 mL of tetrahydrofuran (Aldrich) were added to the mixture and stirring was performed at 25° C. for 36 hours. Thereafter, layer separation was performed and a product layer was extracted with methylene chloride (Aldrich), moisture was removed from the extract with magnesium sulfate (Aldrich), and the solvent was dried under vacuum to obtain an epoxy siloxane-based resin.

30 g of the epoxy siloxane-based resin as prepared above, 10 g of (3′,4′-epoxycyclohexyl)methyl 3,4-epoxycyclohexanecarboxylate and 5 g of bis[(3,4-epoxycyclohexyl)methyl] adipate as a crosslinking agent, 0.5 g of (4-methylphenyl)[4-(2-methylpropyl)phenyl]iodoniumhexafluorophosphate as a photoinitiator, and 54.5 g of methylethyl ketone were mixed to prepare a hard coating composition.

### [Preparation Example 3] Preparation of Acrylic Hard Coating Layer Forming Composition

91 g of pentaerythritol triacrylate (PETA), 3 g of first silica fine particles having a particle diameter of 15 nm (surface treatment: 3-Methacryloyloxy propylmethyldimethoxysilane, and a solid content of 1.95 g of a photoinitiator (Irgacure 184, Ciba) were diluted in a methyl ethyl ketone (MEK) solvent so that the solid concentration was 35 wt % to prepare a composition for a substrate layer.

### Example 1

The shatterproof layer forming composition prepared in Preparation Example 1 was applied on one surface of a glass substrate (UTG 40 μm) with a #8 mayer bar, dried at 50° C. for 1 minute, and dried at 230° C. for 10 minutes to form a polyimide-based shatterproof layer having a thickness of 3 μm. Then, the hard coating layer forming composition prepared in Preparation Example 2 was coated on the other surface of the glass substrate which was not coated with a #10 bar, dried at 65° C. for 3 minutes, and irradiated with an ultraviolet ray of 300 mJ/cm² to produce a glass substrate multilayer structure in which a hard coating layer having a thickness of 5 μm was formed.

### Example 2

A glass substrate multilayer structure was produced in the same manner as in Example 1, except that the thickness of the polyimide-based shatterproof layer was 5 μm and the thickness of the hard coating layer was 5 μm.

### Example 3

A glass substrate multilayer structure was produced in the same manner as in Example 1, except that the thickness of the polyimide-based shatterproof layer was 10 μm and the thickness of the hard coating layer was 5 μm.

### Comparative Example 1

A glass substrate multilayer structure was produced in the same manner as in Example 3, except that the hard coating layer was formed on the polyimide-based shatterproof layer.

### Comparative Example 2

A glass substrate multilayer structure was produced in the same manner as in Example 3, except that the hard coating layer was formed using the hard coating layer forming composition prepared in Preparation Example 3.

The physical properties of the glass substrate multilayer structures produced in Examples 1 to 3 and Comparative Examples 1 and 2 were measured and are shown in the following Table 1. The following Table 1 shows a multilayer structure of the front surface and the rear surface based on the glass substrate.

TABLE 1

| | | | | | | Impact | | | | |
|---|---|---|---|---|---|---|---|---|---|---|
| | | | Hard | | | resistance | | Yellow | Light | |
| | | | coating | Shatterproof | Surface | properties | Bending | index | transmittance | Retardation |
| | | | layer | layer | hardness | (result/height) | (unit: mm) | (YI) | (unit: %) | (Rₜₕ) |
| Example | 1 | Thickness | 5 | 3 | 5H | ⊚/10 cm | 0.05 | 1.3 | 99.2 | 21 |
| | | (μm) | | | | | | | | |
| | | Composition | Preparation | Preparation | | | | | | |
| | | | Example 2 | Example 1 | | | | | | |
| | 2 | Thickness | 5 | 5 | 4H | ⊚/15 cm | 0.01 | 1.5 | 99.1 | 32 |
| | | (μm) | | | | | | | | |
| | | Composition | Preparation | Preparation | | | | | | |
| | | | Example 2 | Example 1 | | | | | | |
| | 3 | Thickness | 5 | 10 | 4H | ⊚/25 c | 0.07 | 1.5 | 99.1 | 33 |
| | | (μm) | | | | | | | | |
| | | Composition | Preparation | Preparation | | | | | | |
| | | | Example 2 | Example 1 | | | | | | |
| Comparative | 1 | Thickness | 5 | 10 | 4H | X/cm | −0.8 | 2.1 | 99.0 | 52 |
| Example | | (μm) | | | | | | | | |
| | | Composition | Preparation | Preparation | | | | | | |
| | | | Example 2 | Example 1 | | | | | | |
| | 2 | Thickness | 5 | 10 | 4H | X/1 cm | −1.5 | 1.4 | 99.2 | 22 |
| | | (μm) | | | | | | | | |
| | | Composition | Preparation | Preparation | | | | | | |
| | | | Example 3 | Example 1 | | | | | | |

As seen in Table 1, it was found that Examples 1 to 3 had an excellent surface hardness of 4H or more, and also, had excellent shatter resistant properties and impact resistance properties even at a height of 10 cm or higher.

Furthermore, in Examples 1 to 3 in which the polyimide-based shatterproof layer was formed on one surface of the glass substrate of a thin plate and the epoxy siloxane-based hard coating layer was formed on the other surface of the glass substrate, it was found that a bending occurrence was low and physical properties such as a light transmittance, a yellow index, and a retardation were excellent.

However, in Comparative Example 1 in which a hard coating layer/a shatterproof layer/a glass substrate were formed in this order, it was found that the hard coating layer and the shatterproof layer were formed using the material having the same composition as Example 3, but the shatter resistant properties (impact resistance) were significantly poor. In addition, in Comparative Example 2 in which an acrylic hard coating layer was formed, it was found that the shatter resistant properties were significantly poor and the bending of the glass substrate multilayer structure was −1.5 mm, which was very high.

The glass substrate multilayer structure of the present disclosure solves a deformation problem of a thin film glass substrate multilayer structure arising due to a tensile stress phenomenon of a shatterproof layer when the shatterproof layer is formed on a conventional flexible thin film glass substrate, and simultaneously, has no pen mark on a shatterproof layer when a pen is dropped from a high position of 30 cm or higher in a pen drop test. In addition, the glass substrate multilayer structure of the present disclosure has a high surface hardness, is flexible, and has excellent thermal resistance and optical properties.

The glass substrate multilayer structure of the present disclosure has an epoxy siloxane-based hard coating layer formed on one surface of a flexible glass substrate and adopts a polyimide-based shatterproof layer, in particular, a fluorine-containing polyimide, on the other surface of the flexible glass substrate, so that reciprocal tensile stress properties between the shatterproof layer and the hard coating layer are well-balanced, thereby having a very good effect of preventing deformation of a glass substrate or deformation of a glass substrate multilayer structure by an external stress such as thermal hysteresis and, in particular, not causing long-term deformation.

The glass substrate multilayer structure of the present disclosure has a polyimide-based shatterproof layer and an epoxy siloxane-based hard coating layer showing different thermal behaviors formed on opposite surfaces to each other with a flexible glass substrate interposed therebetween, thereby having a surprising effect that thermal deformation of the flexible glass substrate is suppressed and the polyimide-based shatterproof layer and the epoxy siloxane-based hard coating layer suppress each other's deformation. Furthermore, the polyimide-based shatterproof layer and the epoxy siloxane-based hard coating layer have a thickness of 10 μm or less to achieve a light weight, a shattering phenomenon when a glass substrate is broken is improved, and significantly improved impact resistance (pen drop) properties may be implemented, and thus, pen application is allowed on a thickness in a level of a conventional cover window formed of a plastic substrate.

Hereinabove, although the present disclosure has been described by specific matters, limited exemplary embodiments, and drawings, they have been provided only for assisting the entire understanding of the present disclosure, and the present disclosure is not limited to the exemplary embodiments, and various modifications and changes may be made by those skilled in the art to which the present disclosure pertains from the description.

Therefore, the spirit of the present disclosure should not be limited to the above-described exemplary embodiments, and the following claims as well as all modified equally or equivalently to the claims are intended to fall within the scope and spirit of the disclosure.

What is claimed is:

1. A glass substrate multilayer structure comprising:
a flexible glass substrate;
an epoxy siloxane-based hard coating layer formed on one surface of the flexible glass substrate; and
a polyimide-based shatterproof layer formed on the other surface of the flexible glass substrate.

2. The glass substrate multilayer structure of claim 1, wherein the polyimide-based shatterproof layer is formed by comprising a polyimide-based resin comprising a unit derived from a fluorine-based aromatic diamine and a unit derived from an aromatic dianhydride.

3. The glass substrate multilayer structure of claim 1, wherein the epoxy siloxane-based hard coating layer is formed by comprising an epoxy siloxane-based resin comprising a unit derived from an alicyclic epoxidized silsesquioxane-based compound.

4. The glass substrate multilayer structure of claim 1, wherein the flexible glass substrate has a thickness of 1 μm to 100 μm.

5. The glass substrate multilayer structure of claim 1, wherein the polyimide-based shatterproof layer has a thickness of 100 nm to 10 μm.

6. The glass substrate multilayer structure of claim 1, wherein the epoxy siloxane-based hard coating layer has a thickness of 1 μm to 5 μm.

7. The glass substrate multilayer structure of claim 1, wherein the epoxy siloxane-based hard coating layer has a pencil hardness of 4H to 6H in accordance with ASTM D3363.

8. The glass substrate multilayer structure of claim 1, wherein the epoxy siloxane-based hard coating layer has a transmittance of 90% or more.

9. The glass substrate multilayer structure of claim 1, wherein the glass substrate multilayer structure has an impact resistance of 10 cm or more by a pen drop test.

10. A method of producing a glass substrate multilayer structure, the method comprising:
applying a shatterproof composition on one surface of a flexible glass substrate and curing the shatterproof composition to form a polyimide-based shatterproof layer; and
applying a hard coating composition on the other surface of the flexible glass substrate and curing the hard coating layer to form an epoxy siloxane-based hard coating layer.

11. The method of producing a glass substrate multilayer structure of claim 10, wherein the shatterproof composition comprises a fluorine-based aromatic diamine and an aromatic dianhydride.

12. The method of producing a glass substrate multilayer structure of claim 10, wherein the hard coating composition comprises an epoxy siloxane-based resin comprising a unit derived from an alicyclic epoxidized silsesquioxane-based compound, a crosslinking agent, and a photoinitiator.

13. A flexible display comprising the glass substrate multilayer structure of claim 1.
